(19) United States
(12) Patent Application Publication
(10) Pub. No.: US 2016/0120197 A1
(43) Pub. Date: May 5, 2016

(54) MILK FROTHER CLEANING COMPOSITION

(71) Applicant: CAFETTO PTY LTD, Brompton (AU)

(72) Inventor: Christopher Gerald ASTLEY, Aldgate (AU)

(21) Appl. No.: 14/892,956

(22) PCT Filed: May 23, 2014
(86) PCT No.: PCT/AU2014/000541

§ 371 Date: Nov. 20, 2015

(30) Foreign Application Priority Data
May 23, 2013 (AU) 2013901845

(51) Int. Cl. A23C 7/02; C11D 3/20; A01N 37/36; C11D 1/94; A01N 43/16; C11D 1/66; C11D 1/88

(52) U.S. Cl. CPC A23C 7/02; C11D 1/662; C11D 3/2086; C11D 1/88; C11D 1/94; A01N 43/16; A01N 37/36

(57) ABSTRACT

Disclosed herein is a composition for cleaning milk products from and sanitising food or beverage preparation devices such a mills frothers of espresso coffee machines. The composition comprises a C₁-C₆ organic acid and an alkyl polyglucoside. Also disclosed herein is a method for cleaning milk or milk products from food or beverage preparation devices and also sanitising said devices. The method comprises contacting a surface of the device that has been in contact with milk with, the above mentioned composition for a time and at a temperature sufficient to clean and sanitise the surface.

### PRIORITY DOCUMENT

The present application claims priority from Australian Provisional Patent Application No. 2013901845 titled “MILK FROTHER CLEANING COMPOSITION” and filed on 23 May 2013, the content of which is hereby incorporated by reference in its entirety.

### FIELD

Disclosed herein are cleaning compositions. More specifically, disclosed herein are sanitising cleaning compositions that are particularly suitable for use on devices that are in regular contact with milk or milk-derived products, such as milk frothers on espresso coffee machines.

### BACKGROUND

Espresso coffee machines having a facility for frothing milk are widely used in domestic, office and commercial settings. Many automatic or semi-automatic espresso coffee machines have built in milk tanks or milk frothing systems whereby heated and/or frothed milk is produced and dispensed into a cup via a froth dispensing tube. It is common for milk residues to remain in the froth dispensing tube or other tubes associated with the milk frothing system after use. Milk residues are a very good nutritional source for bacteria and, therefore milk frothing systems can become infected with undesirable bacteria. Furthermore, a build-up of milk residues in tubes of the milk frothing systems can lead to partial blockage with a resultant loss in performance of the milk frothing system.

For the reasons mentioned above, milk frothing systems need to be cleaned and sanitised on a daily basis to keep them safe. This is typically done by pumping a solution of a milk frother cleaning and sanitation product through the milk frothing system. To this end, various cleaning and sanitising compositions are available commercially. For example, some prior art cleaning and sanitising compositions contain a quaternary ammonium compound as an active ingredient and some of these also contain tetrasodium ethylenediaminetetraacetate to assist with cleaning and scale removal. Other compositions use chlorine based ingredients to provide sanitation to the milk line.

Many consumers are reluctant to use known milk frother cleaning compositions because many of them contain “harsh” chemicals that can cause skin irritations and/or concerns regarding any residues remaining after cleaning of devices that are used for food or beverage production. Compositions that use chlorine based ingredients can lead to corrosion of components of the milk frothing system or machine, they have an unpleasant odour and any residues left behind after cleaning can subsequently taint milk. Some of these products also have a relatively short shelf life. Furthermore, there is a growing preference among consumers in the marketplace for organic approved products. With this in mind, we initially developed a composition that contained a biodegradable sequestrant system, an alkyl polyglucoside surfactant and a quaternary ammonium sanitiser. This gave good cleaning and sanitising performance but could not be certified as an organic product by OMRI (Organic Materials Review Institute) in the USA or BFA (Biological Farmers Australia) because of the presence of the quaternary ammonium compound.

There is a need for cleaning compositions that overcome one or more of the problems associated with prior art cleaning compositions. Alternatively, or in addition, there is a need for cleaning compositions that provide users with a useful alternative.

### SUMMARY

The present invention results from our research in to cleaning compositions for both sanitising and cleaning milk frothers and other food and beverage preparation devices and machinery that come into contact with milk or milk-derived products that could be certified as suitable for use in organic systems. The compositions are particularly suitable for use in a range of applications in which milk and milk-derived products come into contact with surfaces, including milk frothing systems in domestic, office and commercial coffee machines, dairy processing machinery, lines, etc. Advantageously, certified organic cleaning compositions described herein may be used in organic dairy processing applications and/or in place of harsher chemical cleaning techniques such as washing with caustic solutions.

In a first aspect, provided herein is a composition for cleaning milk products from and sanitising food or beverage preparation devices, the composition comprising a C₁-C₆ organic acid and an alkyl polyglucoside.

Specifically, the composition is particularly suitable for cleaning and sanitising food or beverage preparation devices that are in regular contact with milk or milk-derived products. Thus, in a second aspect, provided herein is a milk frother cleaning and sanitising composition, the composition comprising a C₁-C₆ organic acid and an alkyl polyglucoside.

In embodiments of the first and second aspects, the composition is a liquid or solution. In these embodiments, the composition may further comprise water. In other embodiments of the first and second aspects, the composition is a solid or gel, such as a powder, tablet, pellet, granule or gel. In these embodiments, the composition may be used in this form or it may be dissolved or suspended in a liquid, such as water, prior to use.

In embodiments of the first and second aspects, the composition contains the C₁-C₆ organic acid in an amount of from about 5% (w/w) to about 70% (w/w).

In embodiments of the first and second aspects, the C₁-C₆ organic acid is lactic acid.

In embodiments of the first and second aspects, the alkyl polyglucoside is a coconut alkyl polyglycoside. In embodiments of the first and second aspects, the composition contains the alkyl polyglucoside in an amount of from about 0.1% (w/w) to about 20% (w/w).

Optionally, the composition may also comprise a minor amount of an amphoteric surfactant. In embodiments, the amphoteric surfactant is present in an amount of from about 0.1% (w/w) to about 5% (w/w). The amphoteric surfactant may be an amine oxide amphoteric surfactant.

Advantageously, lactic acid, the alkyl polyglucoside and, if present, the amine oxide amphoteric surfactant are certified for use in organic systems and applications and, therefore, the composition is suitable for use in such systems. Thus, in a third aspect, provided herein is an organic certifiable composition for cleaning milk products from and sanitising food or beverage preparation devices, the composition comprising a C₁-C₆ organic acid and an alkyl polyglucoside.

As with the first and second aspects, in embodiments of the third aspect the composition is a liquid or solution. In these embodiments, the composition may further comprise water. In other embodiments of the third aspect, the composition is a solid or gel, such as a powder, tablet, pellet, granule or gel. In these embodiments, the composition may be used in this form or it may be dissolved or suspended in a liquid, such as water, prior to use.

In embodiments of the first, second and third aspects, the composition comprises substantially no anionic surfactant. Thus, in a fourth aspect, provided herein is a composition for cleaning milk products from and sanitising food or beverage preparation devices, the composition consisting essentially of from about 5% (w/w) to about 70% (w/w) of a C₁-C₆ organic acid, from about 0.1% (w/w) to about 20% (w/w) of an alkyl polyglucoside, from about 0.1% (w/w) to about 5% (w/w) of an amine oxide amphoteric surfactant, and water.

In a fifth aspect, provided herein is a composition for cleaning milk products from and sanitising food or beverage preparation devices, the composition consisting essentially of 20-30% (w/w) lactic acid, 2-4% (w/w) alkyl polyglucoside, 0.5-1.0% (w/w) amine oxide amphoteric surfactant, and water.

Liquid forms of the compositions of the first to fifth aspects may be in the form of a ready-to-use solution or in the form of a concentrate suitable for dilution prior to use.

In a sixth aspect, provided herein is a method for cleaning milk or milk products from food or beverage preparation devices and also sanitising said devices, the method comprising contact a surface of the device that has been in contact with milk with the composition of the first to fifth aspects for a time and at a temperature sufficient to clean and sanitise the surface.

Microbial screening of compositions according to the first to fifth aspects showed strong antibacterial activity against Listeria monocytogenes, Staphylococcus aureus, Salmonella chlorasuis, Escherichia coli, Salmonella cholereasius, and Listeria monocytogenes. Accordingly, in a seventh aspect, provided herein is an antibacterial composition comprising a C₁-C₆ organic acid and an alkyl polyglucoside. In embodiments, the antibacterial composition is suitable for cleaning milk products from and sanitising food or beverage preparation devices. In embodiments, the composition is used to reduce the number of bacteria on a surface, wherein the bacteria are selected from one or more of the group consisting of: Listeria monocytogenes, Staphylococcus aureus, Salmonella chloreasuis, Escherichia coli, Salmonella cholereasius, and Listeria nonocytogenes.

### BRIEF DESCRIPTION OF THE FIGURES

Embodiments will be discussed with reference to the accompanying drawings wherein:

FIG. 1 shows a plot of % milk stone removal for compositions at 20° C. ( [symbol] ), 40° C. ( [symbol] ) and 70° C. ( [symbol] ); and

FIG. 2 shows a plot of % milk stone removal for compositions 70° C.

### DESCRIPTION OF EMBODIMENTS

Before describing the present invention in detail, it is to be understood that this invention is not limited to particularly exemplified systems or process parameters that may, of course, vary. For ease of description reference will be made to use of the composition as a milk frother cleaner but it will be appreciated that the composition is not limited in its use to that particular application and could be used in other applications in which milk or milk-derived products come into contact with surfaces, such as in the dairy industry. It is also to be understood that the terminology used herein is for the purpose of describing particular embodiments of the invention only, and is not intended to limit the scope of the invention in any manner.

Provided herein is a cleaning composition. The composition is especially suited to cleaning milk products from and sanitising food or beverage preparation devices. A typical use of the cleaning composition is to clean and sanitise milk frother systems on espresso coffee machines.

The composition comprises a C₁-C₆ organic acid and an alkyl polyglucoside. In embodiments, the only active ingredients in the composition are naturally derived products and, therefore, the product is a “natural” or “organic” cleaning composition. Therefore, provided herein is an organic certifiable composition for cleaning milk products from and sanitising food or beverage preparation devices, the composition comprising a C₁-C₆ organic acid and an alkyl polyglucoside.

The C₁-C₆ organic acid may be any water soluble molecule having from one to six carbon atoms in the normal chain and at least one carboxyl group. Suitable C₁-C₆ organic acids include: acetic acid, citric acid, propionic acid, butyric acid, valeric acid, malonic acid, succinic acid, glutaric acid, adipic acid, pimelic acid, fumaric acid, maleic acid, glutamic acid, aspartic acid, glycolic acid, lactic acid, hydroxyacrylic acid, α-hydroxybutyric acid, glyceric acid, tartronic acid, malic acid, tartaric acid, and citric acid. C₁-C₆ organic acids suitable for use in the compositions are widely available from various commercial sources.

The composition may contain the C₁-C₆ organic acid in an amount of from about 5% (w/w) to about 70% (w/w). A minimum concentration of the C₁-C₆ organic acid may be required for the composition to be anti-bacterial and the amount required may depend on the specific organic acid used. An effective amount of the organic acid can be determined empirically using methods readily available in the art.

In embodiments, the C₁-C₆ organic acid is lactic acid. Lactic acid is safe for human consumption and also has antibacterial properties that assist in sanitisation of the food or beverage preparation devices. The composition may contain lactic acid in an amount of from about 5% (w/w) to about 70% (w/w). In specific embodiments, the composition contains lactic acid in an amount of 20-30% (w/w), such as about 26% (w/w).

The cleaning compositions contain at least one alkyl polyglucoside surfactant. As the term is used herein, a “surfactant” is a substance or compound that reduces surface tension when dissolved in water or water solutions, or that reduces interfacial tension between two liquids, or between a liquid and a solid. The term “surfactant” thus includes cationic, anionic, nonionic and/or amphoteric agents. We tested a series of lactic acid compositions containing sodium lauryl sulphate (SLS) (an anionic surfactant), alkyl polyglucoside (APG) (a non-ionic surfactant), and blends of the two surfactants. Initially, sodium lauryl sulphate was chosen because the literature referred to its enhancement of the anti-bacterial properties of lactic acid (Byelashov, et al., J Food Prot. 2008; 71(4):728-34). The alkyl polyglucoside was chosen for its environmental acceptability and known cleaning performance.

We found that sodium lauryl sulphate had significantly lower milkstone removal than the alkyl polyglucoside formula at 63.6% compared to 93.8% with a blend of the two being in between. Other anionic and non-ionic surfactants were evaluated but the alkyl polyglucoside had the best results by a large margin.

Thus, we have found that a combination of alkyl polyglucoside and organic acid is synergistic. The alkyl polyglucoside surfactant may have a naturally derived alkyl substituent, such as coconut fatty alcohol. Thus, the alkyl polyglucoside may be made from renewable resources. In embodiments, the cleaning composition has an absence of other surfactants or substantially no additional surfactant, such as anionic, nonionic, cationic, and amphoteric surfactants. Indeed, in embodiments the composition comprises substantially no anionic surfactant.

Alkyl polyglucosides (APGs) are a class of non-ionic surfactants derived from glucose and fatty alcohols. Advantageously, they are manufactured from renewable resources with the raw materials for their manufacture typically being glucose and fat.

Suitable alkyl polyglucoside surfactants are the alkylpolysaccharides that are disclosed in U.S. Pat. No. 5,776,872 to Giret et al.; U.S. Pat. No. 5,883,059 to Furman at al.; U.S. Pat. No. 5,883,062 to Addison et al.; and U.S. Pat. No. 5,906,973 to Ouzounis et al., all of which are incorporated by reference. Suitable alkyl polyglucosides have a hydrophobic group containing from about 6 to about 30 carbon atoms, or from about 10 to about 16 carbon atoms and polysaccharide, e.g., a polyglycoside (polyglucoside), hydrophilic group containing from about 1.3 to about 10, or from about 1.3 to about 3, or from about 1.3 to about 2.7 saccharide units. Typical hydrophobic groups include alkyl groups, either saturated or unsaturated, branched or unbranched containing from about 8 to about 18, or from about 10 to about 16, carbon atoms. Suitably, the alkyl group can contain up to about 3 hydroxy groups and/or the polyalkyleneoxide chain can contain up to about 10, or less than about 5, alkyleneoxide moieties. Suitable alkyl polysaccharides are octyl, nonyldecyl, undecyldodecyl, tridecyl, tetradecyl, pentadecyl, hexadecyl, heptadecyl, and octadecyl, di-, tri-, tetra-, penta-, and hexaglucosides, galactosides, lactosides, glucoses, fructosides, fructoses and/or galactoses. Suitable mixtures include coconut alkyl, di-, tri-, tetra-, and pentaglucosides and tallow alkyl tetra-, penta-, and hexaglucosides.

Suitable alkylglycosides include, for example, APG 425™ (a coconut alkyl polyglycoside having naturally derived components available from Cognis Corporation), APG 325™ (a C₉-C₁₁ alkyl polyglycoside available from Cognis Corporation), APG 625™ (a C₃₀-C₁₆ alkyl polyglycoside available from Cognis Corporation), Dow Triton™ CG110 (a C₈-C₁₀ alkyl polyglycoside available from Dow Chemical Company), AG6202™ (a C₈ alkyl polyglycoside available from Akzo Nobel) and Alkadet 15™ (a C₈-C₁₀ alkyl polyglycoside available from Huntsman Corporation).

In embodiments, the composition contains the alkyl polyglucoside in an amount of from about 0.1% (w/w) to about 20% (w/w). In specific embodiments, the composition contains the alkyl polyglucoside in an amount of about 3% (w/w).

In specific embodiments, the alkyl polyglucoside is APG 425™ and is present in an amount of 2-4% (w/w), such as about 3% (w/w).

As discussed, we found that anionic surfactants reduced the cleaning performance of the composition. Therefore, a range of amphoteric surfactants were evaluated as these would have some cationic character in acidic conditions. The addition of a small amount of amphoteric amine oxides to compositions comprising lactic acid and alkyl polyglucoside gave an increase in anti-microbial kill.

Thus, in embodiments the composition further comprises a minor amount of an amphoteric surfactant. The amphoteric surfactant may be selected from the group consisting of: amine oxides, such as coco dimethylamine oxide; disodium cocoamphodipropionate (commercially available under the trade name Miranol C2MSF); and cocamidopropyl betaine (commercially available under the trade name Dehyton KE). The amphoteric surfactant may be present in an amount of from about 0.1% (w/w) to about 5% (w/w).

In specific embodiments, the amphoteric surfactant is an amine oxide. The amine oxide may be coco dimethylamine oxide (commercially available under the trade name Keminox DM24). In specific embodiments, the amphoteric surfactant is Keminox DM24 and it is present in the composition in an amount of 0.5-1.0% (w/w), such as about 0.9% (w/w).

Microbial screening of a composition comprising lactic acid, APO and Keminox DM24 against Listcria monocytogenes, Staphylococcus aureus and Salmonella chloreasuis at 30° C. and against Escherichia coli, Salmonella cholereasius and Listeria monocytogenes at 40° C. showed a >log 5 reduction. Thus, the composition provided herein is an antibacterial composition comprising a C₁-C₆ organic acid and an alkyl polyglucoside. The antibacterial composition is suitable for cleaning milk products from and sanitising food or beverage preparation devices. The composition is used to reduce the number of bacteria on a surface, wherein the bacteria are selected from one or more of the group consisting of: Listeria monocytogenes, Staphylococcus aureus, Salmonella chloreasuis, Escherichia coli, Salmonella cholereasius, and Listeria monocytogenes.

Testing was also carried out on blends with small additions of SLS but even small additions led to a significant loss in performance. Thus, in embodiments the composition contains substantially no anionic surfactant.

It will be evident from the foregoing description that specific embodiments provide a composition for cleaning milk products from and sanitising food or beverage preparation devices, the composition consisting essentially of from about 5% (w/w) to about 70% (w/w) of a C₁-C₆ organic acid, from about 0.1% (w/w) to about 20% (w/w) of an alkyl polyglucoside, from about 0.1% (w/w) to about 5% (w/w) of an amine oxide amphoteric surfactant, and water. In specific embodiments, the composition consists essentially of 20-30% (w/w) lactic acid, 2-4% (w/w) alkyl polyglucoside, 0.5-1.0% (w/w) amine oxide amphoteric surfactant, and water.

The composition may be a liquid, solution, suspension, emulsion, gel, powder, tablet, pellet or granule. The form of the composition may depend, at least in part, on the properties of the C₁-C₆ organic acid and the alkyl polyglucoside. For example, if any one of these components is normally in a liquid form at room temperature then the composition will most preferably be in the form of a liquid, solution, suspension, emulsion or gel. Alternatively, if the components in the composition are all solids as room temperature then the composition may be in a solid form. Suitable solid forms include powders, tablets, pellets and granules.

Thus, in some embodiments, the composition is a liquid. In these embodiments, the composition may further comprise water. In these embodiments, the remainder of the composition may be water. Deionized or filtered water is preferred. The liquid may in the form of a ready to use solution that does not require dilution, or in the form of a concentrated liquid that can be diluted with water prior to use.

In other embodiments the composition is a solid. In these embodiments, the composition may further comprise solid excipients, diluents, fillers or adjuvants. For example, the composition may be in the form of a tablet that is formed by compressing the components of the composition with one or more fillers, such as cellulose, dibasic calcium phosphate, lactose, sucrose, glucose, mannitol, sorbitol, calcium carbonate, magnesium stearate and the like. Alternatively, the solid components of the composition may be granulated using granulations techniques know in the art. In these forms, the composition can be used as is (i.e. in a solid form) or it may be dissolved or suspended in a liquid, such as water, prior to use. Alternatively, powders, tablets and other suitable solid forms of the composition may be added directly to a container in an espresso machine and the machine can then automatically run a cleaning cycle that dissolves the powder, tablet or other solid form and pumps it through.

The composition may be reconstituted, dissolved or diluted prior to or during use. Therefore, it will be appreciated that, unless otherwise stated, the amounts stated herein refer to the composition prior to dilution. Typically, the composition will be diluted with water. The dilution may be from about 1:1 to about 1:50. In embodiments, the dilution is 1:1, 1:5, 1:10, 1:20, 1:30, 1:40 or 1:50. In specific embodiments, the dilution is 1:20.

The pH of the cleaning composition may be between about 1 and about 4. In some embodiments, the pH of the cleaning composition is between about 1 and about 2, such as 1.0, 1.1, 1.2, 1.3, 1.4, 1.5, 1.6, 1.7, 1.8, 1.9, and 2.0. In specific embodiments, the pH of the cleaning composition is about 1.7.

The amounts of C₁-C₆ organic acid and alkyl polyglucoside in the composition may be determined or adjusted depending on the degree to which the composition is to be diluted. For example, a minimum concentration of lactic acid of 1% (w/w) in the diluted composition as used may be required for the composition to be anti-bacterial.

The compositions provided herein are especially suitable for descaling and/or cleaning milk or milk products from food or beverage preparation devices and also sanitising said devices. A surface of a device that has been in contact with milk is contacted with the composition for a time and at a temperature sufficient to clean and sanitise the surface.

A typical milk frother system of a coffee machine comprises a milk pick-up line and a milk frother block where steam is used to create the foam. The temperature of the solution in the pick-up line will be whatever the operator makes the solution at. This can range from cold to warm water. The temperature in the milk frother unit will generally be around 70° C. The most difficult soil to clean is in the milk frother as it is normally baked on. So testing of cleaning efficacy is done at 70° C. The most difficult part to sanitise is the pick-up line as this is not thermally disinfected. For this reason, the disinfectant testing is done at 20 or 40° C. The solution is in the system for at least 1 minute.

It will be evident from the preceding description and the examples below that provided herein are compositions which contain certified organic ingredients and, therefore, are suitable for use in organic systems but also provide excellent cleaning and descaling properties as shown in the milk stone tests below and also excellent antimicrobial properties against a range of bacteria including Listeria monocytogenes, Staphylococcus aureus and Salmonella chloreasuis all of which are problematic in the food and beverage industries.

### EXAMPLES

### Example 1

### Preparation and Milk Stone Testing of Cleaning Compositions Comprising Alkyl Polyglucoside or Anionic Surfactant

Milk frother cleaning compositions comprising the following ingredients were prepared by mixing.

| | (a) | (b) |
|---|---|---|
| Water | 350 | 330 |
| Lactic acid | 150 | 150 |
| Sodium lauryl sulphate (“SLS”) | 15 | — |
| (Ufarol, UNGER) | | |
| Alkyl polyglycoside C8-C14 (“APG”) | — | 30 |
| (Glucopon 425, BASF) | | |
| Water to | 500 | 500 |
| pH (neat) | 1.72 | 1.73 |
| pH (at 1:20 dilution) | 2.29 | 2.24 |

Compositions (a) and (b) were diluted in water (1:20) and used in milk stone tests at 70° C. under standard conditions (Milk Stone Plates, 5 minutes followed by agitation and cold water rinse, Tap, 70° C., 500 mL). For comparative purposes, the same tests were also conducted a commercially available milk frother cleaning composition (DMFC) comprising 1-hydroxy ethylidene-1.1-diphosphonic acid (HEDP), caustic potash, ethylenediaminetetraacetic acid (EDTA), a quaternary ammonium compound, metasilicate, alkyl polyglycoside (Glucopon 425. BASF), disodium cocoamphodipropionate (Miranol C2MSF), and a non-ionic surfactant (Plurafac).

| | | | Average | Standard |
|---|---|---|---|---|
| | Concentration | Removal (%) | Removal (%) | Deviation |
| DMFC | 50 g/L | 60.67 | 56.2 | 6.30 |
| | | 51.76 | | |
| (a) | 50 g/L | 78.06 | 79.9 | 2.54 |
| | | 81.66 | | |
| (b) | 50 g/L | 93.33 | 92.7 | 0.87 |
| | | 92.11 | | |

### Example 2

### Preparation and Milk Stone Testing of Cleaning Compositions Comprising Alkyl Polyglucoside and Anionic Surfactant

A 50:50 mixture of compositions (a) and (b) was then prepared and had the following composition.

| | (c) |
|---|---|
| Water | 350 |
| Lactic acid | 150 |
| Sodium lauryl sulphate (“SLS”) | 7.5 |
| (Ufarol, UNGER) | |
| Alkyl polyglycoside C8-C14 (“APG”) | 15 |
| (Glucopon 425, BASF) | |
| Water to | 500 |

Compositions (a), (b) and (c) were diluted in water (1:20) and used in milk stone tests at 70° C. under standard conditions (Milk Stone Plates, 5 minutes followed by agitation and cold water rinse, Tap, 70° C., 500 mL). Again, for comparative purposes the same tests were conducted using the commercially available milk frother cleaner DMFC.

| | | Removal | Average | Standard |
|---|---|---|---|---|
| | Concentration | (%) | Removal (%) | Deviation |
| DMFC | 50 g/L | 50.98 | 47.1 | 5.54 |
| | | 43.15 | | |
| (a) | 50 g/L | 62.21 | 63.6 | 1.96 |
| | | 64.98 | | |
| (b) | 50 g/L | 96.59 | 93.8 | 3.89 |
| | | 91.08 | | |
| (c) | 50 g/L | 82.87 | 83.4 | 0.76 |
| | | 83.95 | | |

### Example 3

### Biological Testing: Effect of Anionic Surfactant

Compositions were tested against E. coli at 40° C. in commercial tests (Silliker Australia). Composition (b) gave a >log 5 reduction in E. coli and was the best performed composition in the tests.

The same biological tests were then conducted with composition (b) at 20° C. and it gave a log 4.3 reduction in E. coli from 6.5×10⁷ to 3.3×10³.

The test showed that antimicrobial performance of the compositions dropped as more of the anionic surfactant SLS was added.

### Example 4

### Milk Stone Testing: Effect of Anionic Surfactant

Composition (b) was tested against the same composition with 0.4% Ufarol (SLS) added. Testing was conducted at 40° C. and 70° C. using standard milk stone tests (Milk Stone Plates, 5 minutes followed by agitation and cold water rinse, Tap, 500 mL) and the results are shown in the table below.

Average Removal (%)

| | Concentration | 40° C. | 70° C. |
|---|---|---|---|
| (b) | 50 g/L | 66.67 | 83.7 |
| (b) + 0.4% | 50 g/L | 62.49 | 68.16 |
| Ufarol SLS | | | |

The tests showed that the addition of even small amounts of anionic surfactant leads to a significant drop in performance.

### Example 5

### Milk Stone Testing: Comparison with Other Cleaners

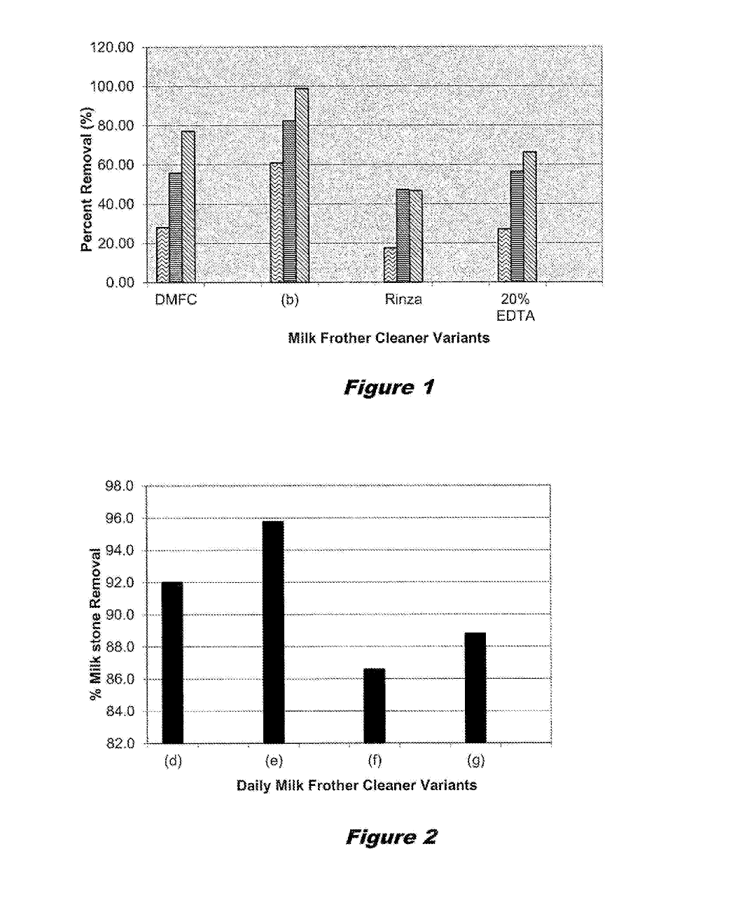

Composition (b) was tested against two commercially available milk frother cleaners (DMFC and Rinza) as well as a composition containing 20% EDTA, a quaternary ammonium compound, alkyl polyglycoside (Glucopon 425, BASF) and Hydropol 90 (referred to as “20% EDTA” in the table). Testing was conducted at 20° C., 40° C. and 70° C. using standard milk stone tests (Milk Stone Plates, 5 minutes followed by agitation and cold water rinse, Tap, 500 mL) and the results are shown in the table below and in FIG. 1.

| | | Average Removal (%) | | |
|---|---|---|---|---|
| | Concentration | 20° C. | 40° C. | 70° C. |
| DMFC | 50 g/L | 28.05 | 55.80 | 77.12 |
| (b) | 50 g/L | 60.97 | 82.27 | 98.68 |
| Rinza | 60 g/L | 17.54 | 47.18 | 46.68 |
| 20% EDTA | 50 g/L | 27.15 | 56.38 | 66.24 |

### Example 6

### Milk Stone Testing: Effect of Amphoteric Surfactants

Amphoteric surfactants become cationic in acid solutions and, therefore, we prepared compositions to see what effect they would have on performance. A composition containing the following ingredients was prepared by mixing.

| | (d) |
|---|---|
| Water | 660 |
| Lactic acid | 300 |
| Alkyl polyglycoside C8-C14 (“APG”) | 60 |
| (Glucopon 425, BASF) | |
| Water to | 1000 |

To this composition, 250 ml portions of the following were added:
Composition (e) 7.5 g Keminox DM24 (coco dimethylamine oxide)
Composition (f) 7.5 g Miranol C2MSF (disodium cocoamphodipropionate)
Composition (g) 7.5 g Dehyton KE (cocamidopropyl betaine)

The milk stone removal testing was conducted on composition (e) and the data are shown in the table below and in FIG. 2. Composition (e) gave the highest milk stone removal.

| | | | Average | |
|---|---|---|---|---|
| | | Removal | Removal | Standard |
| | Concentration | (%) | (%) | Deviation |
| (d) | 50 g/L | 91.56 | 92.0 | 0.66 |
| | | 92.49 | | |
| (e) | 50 g/L | 95.31 | 95.8 | 0.65 |
| | | 96.23 | | |
| (f) | 50 g/L | 84.93 | 86.6 | 2.36 |
| | | 88.27 | | |
| (g) | 50 g/L | 88.67 | 88.8 | 0.20 |
| | | 88.95 | | |

### Example 7

### Biological Testing: Effect of Amphoteric Surfactants

Composition (e) was tested against Listeria monocytogenes NCTC 11994, Staphylococcus aureus ATCC 6538 and Salmonella cholereasius ATCC 10708 by Silliker Australia Pty Ltd. The product concentration was 50 mL/1 L w/w, the contact time was 1 minute, the organic challenge was 0.1% Skim Milk and the temperature was 30° C. The results are shown in the table below.

| | Initial Count | Final Count per mL | Log |
|---|---|---|---|
| Organism | per mL | 1 min | reduction |
| Listeria monocytogenes | 2.0 × 10⁸ | 5.3 × 10² | >5.0 |
| Staphylococcus aureus | 2.6 × 10⁷ | <10 | >5.0 |
| Salmonella cholereasius | 1.3 × 10⁷ | <10 | >5.0 |

Notes:
Counts are Geometric Means of duplicate results

Thus, composition (e) achieved a greater than 5.0 log reduction (>99.999% kill) against the test organisms under the conditions tested.

The same composition, Composition (e), was tested against Escherichia coli ATCC 8739, Salmonella cholereasius ATCC 10708 and Listeria monocytogenes ATCC 13932 by ams Laboratories. The product concentration was 50 mL/1 L w/w, the contact time was 1 minute, the organic challenge was 0.1% Skim Milk and the temperature was 40° C. The results are shown in the table below.

| | |
|---|---|
| | Surviving |
| | organisms (CFU/mL) |
| Inoculum Count | and Log₁₀ Reduction |

| | CFU/mL | Test Inoculum | CFU/mL | Log |
|---|---|---|---|---|
| Organism | (log₁₀) | (log₁₀) | (log₁₀) | reduction |
| Escherichia coli | 2.1 × 10⁸ | 7.38 | <10 | >6.38 |
| | (8.38) | | (<1.00) | |
| Salmonella | 2.9 × 10⁸ | 7.46 | <10 | >6.46 |
| cholereasius | (8.46) | | (<1.00) | |
| Listeria | 1.7 × 10⁸ | 7.23 | 20 | 5.93 |
| monocytogenes | (8.23) | | (1.30) | |

Notes:
CFU: Colony Forming Unit

Thus, composition (e) achieved a greater than 5.0 log reduction (>99.999% kill) against the test organisms under the conditions tested.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

All publications mentioned in this specification are herein incorporated by reference. Any discussion of documents, acts, materials, devices, articles or the like which has been included in the present specification is solely for the purpose of providing a context for the present invention. It is not to be taken as an admission that any or all of these matters form part of the prior art base or were common general knowledge in the field relevant to the present invention as it existed in Australia or elsewhere before the priority date of each claim of this application.

1. A composition for cleaning milk products from and sanitising food or beverage preparation devices, the composition comprising a C₁-C₆ organic acid and an alkyl polyglucoside.

2. (canceled)

3. (canceled)

4. The composition of claim 1 comprising the C₁-C₆ organic acid in an amount of from about 5% (w/w) to about 70% (w/w).

5. The composition of claim 4, wherein the C₁-C₆ organic acid is lactic acid.

6. The composition of claim 1 comprising the alkyl polyglucoside in an amount of from about 0.1% (w/w) to about 20% (w/w).

7. The composition of claim 6, wherein the alkyl polyglucoside is a coconut alkyl polyglycoside.

8. (canceled)

9. The composition of claim 1, further comprising an amphoteric surfactant in an amount of from about 0.1% (w/w) to about 5% (w/w).

10. The composition of claim 9, wherein the amphoteric surfactant is an amine oxide.

11. The composition of claim 10, wherein the amine oxide is coco dimethylamine oxide.

12. The composition of claim 11, wherein the amine oxide is Keminox DM24.

13. The composition of claim 1 comprising substantially no anionic surfactant.

14. The composition of claim 1, further comprising water at a dilution of 1:20.

15. (canceled)

16. The composition of claim 1, wherein the composition is a solid.

17. A composition for cleaning milk products from and sanitising food or beverage preparation devices, the composition consisting essentially of from about 5% (w/w) to about 70% (w/w) of a C₁-C₆ organic acid, from about 0.1% (w/w) to about 20% (w/w) of an alkyl polyglucoside, from about 0.1% (w/w) to about 5% (w/w) of an amine oxide amphoteric surfactant, and water.

18. The composition of claim 17 consisting essentially of 20-30% (w/w) lactic acid, 2-4% (w/w) alkyl polyglucoside, 0.5-1.0% (w/w) amine oxide amphoteric surfactant, and water.

19. The composition of claim 18, wherein the alkyl polyglucoside is a coconut alkyl polyglycoside.

20. The composition of claim 19, wherein the alkyl polyglucoside is the one commercially available under the trade name APG 425™ from Cognis Corporation.

21. The composition of claim 18, wherein the amine oxide amphoteric surfactant is coco dimethylamine oxide.

22. The composition of claim 21 wherein the wherein the amine oxide amphoteric surfactant is the one commercially available under the trade name Keminox DM24.

23. A method for cleaning milk or milk products from food or beverage preparation devices and also sanitising said devices, the method comprising contact a surface of the device that has been in contact with milk with the composition of claim 1 for a time and at a temperature sufficient to clean and sanitise the surface.
